(19) United States
(12) Patent Application Publication
(10) Pub. No.: US 2025/0348742 A1
(43) Pub. Date: Nov. 13, 2025

(54) METHODS, SYSTEMS, ARTICLES OF MANUFACTURE AND APPARATUS TO TRAIN MACHINE LEARNING MODELS USING SEMI-SUPERVISED SIGNALS

(71) Applicant: Nielsen Consumer LLC, Chicago, IL (US)

(72) Inventors: Emilio Javier Almazan, Alcorcon (ES); David Jiménez Cabello, Lupiana (ES)

(21) Appl. No.: 18/658,664

(22) Filed: May 8, 2024

(51) Int. Cl. G06N 3/09; G06N 3/0455

(52) U.S. Cl. CPC G06N 3/09; G06N 3/0455

(57) ABSTRACT

Systems, apparatus, articles of manufacture, and methods are disclosed to train a machine learning model using semi-supervised signals. An example apparatus disclosed herein comprises interface circuitry, machine-readable instructions, and at least one processor circuit to be programmed by the machine-readable instructions to tokenize a first input and a second input to generate first tokens and second tokens, generate context information based on transformer self-attention layer interaction between the first tokens and the second tokens, the self attention layer interaction to generate numerical values for respective ones of the first tokens and the second tokens, insert a first average value of the first tokens to a first group classifier model to predict a first group classification, insert a second average value of the second tokens to a second group classifier model to predict a second group classification, the first and second group classifier models trained with supervised data associated with the first and second inputs, insert masked ones of the first tokens and second tokens to a masked language model, and train a transformer based on an average loss value associated with (a) a first loss value corresponding to the first group classification, (b) a second loss value corresponding to the second group classification, (c) a third loss value corresponding to the MLM, and (d) a fourth loss value corresponding to an object matching neural network.

### FIELD OF THE DISCLOSURE

This disclosure relates generally to large language model (LLM) and, more particularly, to methods, systems, articles of manufacture and apparatus to train machine learning models using semi-supervised signals.

### BACKGROUND

A machine learning model can be trained using supervised and self-supervised data. Supervised data is data that has been annotated or labelled by a human. Self-supervised data is data that has not been human-labeled but may include some label information from other sources. There are two stages in general purpose language modeling. The first stage is a transformer model that is pre-trained with a massive amount of self-supervised data. The second stage is a pre-trained model that is fine-tuned to a downstream task of interest leveraging human annotated data (e.g., supervised data).

### BRIEF DESCRIPTION OF THE DRAWINGS

FIG. 1 is a block diagram of an example environment in which example hybrid model training circuitry operates to pre-train a machine learning model using semi-supervised signals.

FIG. 2 is a block diagram of an example implementation of the hybrid model training circuitry of FIG. 1.

FIG. 3 is an example machine learning model framework to facilitate model training in a semi-supervised manner.

FIGS. 4 and 5 are flowcharts representative of example machine readable instructions and/or example operations that may be executed, instantiated, and/or performed by example programmable circuitry to implement the hybrid model training circuitry of FIG. 2.

FIG. 6 is a block diagram of an example processing platform including programmable circuitry structured to execute, instantiate, and/or perform the example machine readable instructions and/or perform the example operations of FIGS. 4-5 to implement the hybrid model training circuitry of FIG. 2.

FIG. 7 is a block diagram of an example implementation of the programmable circuitry of FIG. 6.

FIG. 8 is a block diagram of another example implementation of the programmable circuitry of FIG. 6.

FIG. 9 is a block diagram of an example software/firmware/instructions distribution platform (e.g., one or more servers) to distribute software, instructions, and/or firmware (e.g., corresponding to the example machine readable instructions of FIGS. 4-5) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

The initial pre-training stages in general-purpose language modeling are highly time consuming and resource demanding. Pre-training a model requires massive amounts of data, sometimes including trillions of words or tokens. This is the most computationally expensive stage in a model pipeline or architecture. The goal of the pre-training stage is to learn the underlying domain or structure of a particular language of interest. Training efforts may include different types of data sources. For instance, some self-supervised data sources include and/or are otherwise built with unlabeled data. In some examples, self-supervised data include and/or are otherwise built with data that may have labels synthetically generated (not human-labeled). Generally speaking, self-supervised data may be either labeled or unlabeled, is voluminous and/or otherwise abundantly available, and used to train a model to understand the domain of the data to be applied to one or more tasks of interest. Training the model to understand the domain of the data ensure the model is closer to the solution when it is trained for one or more downstream tasks of interest.

On the other hand, supervised data sources include labeled data in which the labels are human-generated. Because the labels corresponding to supervised data sources are applied via human labeling efforts, they are more expensive than self-supervised data sources, relatively less voluminous when compared to self-supervised data sources, and labor intensive.

In some examples, a model is initially trained with unlabeled data using a self-supervised learning approach. Self-supervised learning involves training the model to predict the domain or structure of a particular language of interest. In some examples, once the model has been pretrained on the self-supervised data, the model is also trained with supervised data (labelled data). Domains of interest include, but are not limited to data specific to retail environments (e.g., purchase order documents, retail receipts, retail-specific vocabulary, retail-specific abbreviations, etc.), and medical environments (e.g., medical publications having industry-specific vocabulary, industry-specific sentence structures, industry-specific abbreviations), etc.

The domain or structure of a language refers to the organization, classification, and arrangement of data within a specific context or system. Domain or structure information includes the type of data being used, their attributes or properties, and the relationships between words in the domain of interest (e.g., a medical domain, a retail product domain, etc.). Each word or token to be analyzed will have a semantic vector representation that depends on its context. As a result, the knowledge acquired by models disclosed herein enables users to tune the model to downstream tasks such as predicting tasks or summarizing tasks. An example of a predicting task includes predicting whether a movie review is positive or negative. An example of a summarizing task includes summarizing fragments of text. For example, a model can be trained to generate a summary of a document, capturing main points and key information. In another example, a document may include a list of pharmaceutical drugs that are ranked based on a probability of treating a suspected illness or symptoms. The example summarizing task may generate one or more summary output recommendations of which particular pharmaceutical drug that is most likely effective against the candidate ailment and/or symptom(s).

Pre-training a foundational machine learning model is normally conducted in a fully self-supervised manner using self-supervised data because the massive amount of data required for building domain-specific models does not have labels of interest associated with those data in quantities suitable for effective training. A foundational machine learning model is a model that has a good understanding of the domain of the data that will be used in the downstream tasks. A data domain refers to a set of all possible values that a particular data attribute can have. For example, “coke 300 ml” could be a data domain within a larger dataset containing information about beverages, where “coke 300 ml” represents a specific product or item. Models may be trained with data from the domain of interest (e.g., a consumer product domain, a pharmaceutical drug domain, a movie database domain, etc.). This model serves as an optimal starting point for the posterior fine tuning on the tasks of interest (e.g., downstream tasks). Additionally, while foundational models are thought to be general-purpose models, in some examples adding extra self-supervised tasks or signals (in some examples described herein “self-supervised” is used interchangeably with “unsupervised”) during pre-training could bias the model.

In the broader category of unsupervised learning, there are various self-supervised learning techniques where the model learns from raw text data without human-labeled annotations. Masked language model (MLM) technique/tasks are one particular strategy for pre-training a foundational machine learning model in a fully self-supervised manner in a text domain. The text domain can be any type of data that includes textual and/or alphanumeric information. MLM-based techniques are widely used for tasks that involve processing and understanding textual data. Self-supervised data is data that has not been human-labeled. For example, given an input sentence, MLM tasks can mask words in the sentence and try to predict the masked words. The input sentence is intentionally corrupted or withheld, and the goal is to recover the original input. MLM tasks predict those masked words using the rest of the unmasked words as context. If the model correctly predicts the masked words from the context, it means that the model understands the language (e.g., semantics and syntax). For self-supervised data (e.g., large amount of data) synthetically generated labels may be built. Although these (non-human generated) labels specifically target any task of interest, these labels are used to train a model in an effort to understand the domain (e.g., semantics and syntax) of the data. So, when the model is used to learn a downstream task, it is closer to the solution and the training is lighter (e.g., less computationally intensive) and relatively more efficient.

For a model pre-trained with self-supervised data (in some examples described herein self-supervised data is used interchangeably with unsupervised data), self-supervised or unsupervised training tasks or modeling tasks (e.g., Masked Language Model (MLM) or Next Sentence Prediction) are used to tailor the model in a more specific and/or otherwise targeted manner that is relevant to a domain of interest. However, self-supervised training tasks are not always optimal depending on the type of data. For instance, in the case of very short input text, the masking of some input words could lead to different issues such as losing the semantic meaning of an input or breaking the contextualization of the sentence, making it difficult to perform accurate predictions. An example of a very short input text can be “PEP” which could mean PEPSI for one type of domain (e.g., product domain), but mean another word such as “peptides” in another type of domain (e.g., chemistry domain). In these cases, additional information is provided to complement and/or otherwise enrich the input text to address the lack of context or semantic ambiguity. If a large amount of raw proprietary data (e.g., text) and metadata relevant to the training or modeling task at hand and the learning process of the machine learning model is available, this can help with the self-supervised training tasks. For example, some data scientists, companies, entities, and/or researchers have their own raw proprietary data (supervised data), which is private. To illustrate, consider that this example proprietary data is a reference dataset with product descriptions along with information or attributes regarding product category information, product group information, universal product code (UPC) information, department information, weight information, volume information, brand information, etc. These example attributes are referred to as meta-data and this meta-data is not normally leveraged during pre-training of foundational machine learning models. During the pre-training stage of custom language models, examples disclosed herein utilize reference datasets to generate relatively more robust models that are closer to particular business needs by combining supervised tasks or signals with self-supervised tasks or signals. In some examples, supervised tasks include text matching tasks, category identification tasks, and/or taxonomy prediction tasks.

Examples disclosed herein are directed to a semi-supervised pre-training architecture (e.g., model framework) and techniques to build a machine learning model. As used herein, “semi-supervised” refers to a combination of (a) supervised data and/or techniques (e.g., data with human-generated labels) and (b) self-supervised data and/or techniques (e.g., unlabeled data or data in which labels are not human-generated but synthetically generated). Semi-supervised pre-training architectures disclosed herein pre-train a transformer (e.g., a cross-encoder transformer) with self-supervised and supervised tasks (also referred to as self-supervised and supervised modeling tasks). Semi-supervised model training examples disclosed herein are effective in scenarios with limited amounts of labeled data. In some examples disclosed herein, semi-supervised pre-training strategies leverage the metadata associated with raw data (e.g., product descriptions) to train a model for, in some examples, a retail industry. In some examples, semi-supervised pre-training strategies leverage the metadata associated with raw data to train a model in other example industries. For example, the pre-training strategy can be used to train a model in a medical industry, software industry, manufacturing industry or any other example industry.

Example semi-supervised pre-training strategies/techniques and structure disclosed herein includes pre-training a machine learning model with proprietary or industry-specific data and metadata to build a machine learning model that is useful for a particular use-case scenario, such as a particular industry. For instance, some industries have particular nomenclature that is unique and/or otherwise uncommon when compared to self-supervised data sources that train models with unlabeled data.

To illustrate, an industry that studies market activities may refer to a short-form (or compact form) product description of a carbonated cola beverage as “COK COL 330 ML,” which is not a textual description typically found in regular language usage. However, a specific supervised data set may be used that enriches and/or otherwise associates the set of short-form product description information with reference data (e.g., or other contextual information). In some examples, the enriched domain input data facilitates a more efficient ability to reveal an associated natural language form, but examples disclosed herein are not limited thereto. In some examples, reference data includes a product UPC code and predicts a product group based on the product's category or taxonomy. This supervised task trains the model to learn that the above text string to have a relationship to and/or otherwise association with a product, a product group, a size, a category, a brand and/or any other enrichment. In some examples, a model trained in this manner may facilitate tasks during inference to allow interpretation of a short-form input to mean and/or otherwise refer to “Coke Cola product with a bottle volume of 330 milliliters.” In still other examples, a model trained in this manner may facilitate predictions of product group(s), brand(s), size(s), etc.

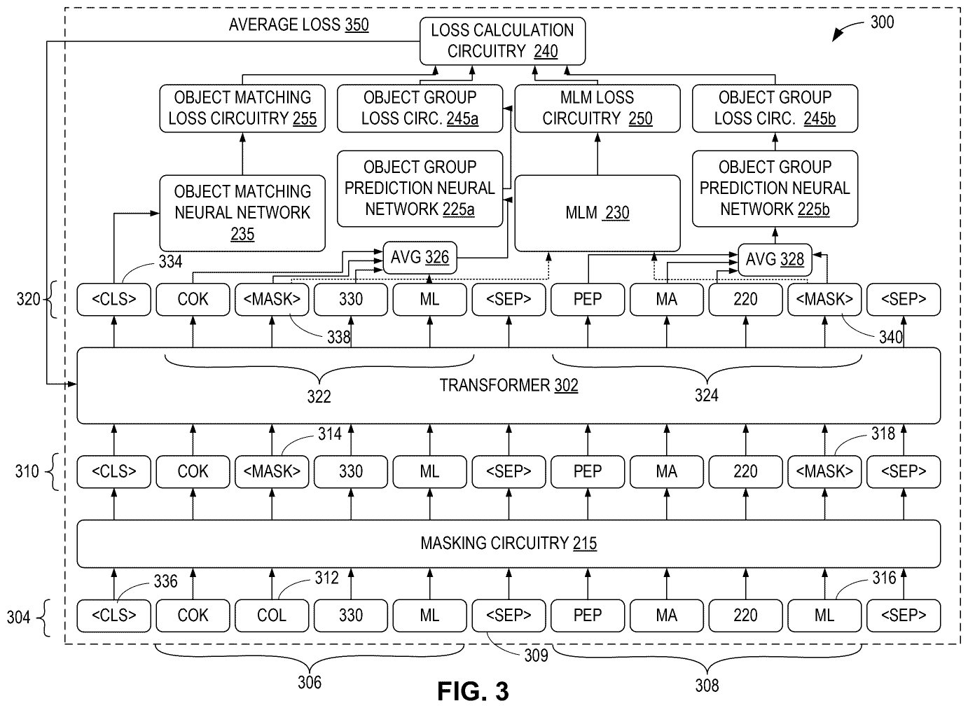

Examples disclosed herein are not limited to product-based industries. To illustrate with an alternate industry associated with the medical field, a patient instruction may include a string of characters that states “Pt. admitted to SNF s/p fall, R hip fx and NWB'ing status.” This string of input (e.g., a short-form input or compact text) is similarly not found in everyday generic parlance with self-supervised data sources (e.g., unlabeled data source). While a generically trained MLM classifier model does not include such unique tokens during a training process with self-supervised data, examples disclosed herein leverage supervised data from specific industries (e.g., the medical industry) to improve model performance and accuracy. In the example above, supervised data includes data with label manually created with human supervision, thereby allowing a trained model to better perform tasks associated with text matching, category prediction and/or taxonomy identification for the string of inputs. A model trained in this manner facilitates an ability to decipher the above input to mean “Patient admitted to a skilled nursing facility status-post with a right hip fracture and non-weight-bearing status.” Accordingly, example models disclosed herein are pre-trained using a cross-encoder transformer (e.g., the transformer receives pairs of input descriptions), and combines a self-supervised task and two supervised tasks to improve model performance during an inference stage. The model is trained based on number of epochs selected as described below in connection with FIG. 3.

An example first pre-training stage disclosed herein for a general-purpose language model is pre-training a transformer model with self-supervised data (e.g., unlabeled data which is abundantly available when compared to relatively less voluminous labeled data (supervised data)). A transformer model is a deep learning model that includes a stack of self-attention layers. As used herein, a self-attention layer is defined herein as a computational layer, circuit, or unit within the transformer model used for capturing contextual information in sequential data. For example, the self-attention layer weighs the importance of different words or tokens in a sequence based on their relationships with each other. In the context of natural language processing (NLP), the transformer model receives a sentence which is a sequence of tokens or words. Each of these tokens is assigned an initial representation (e.g., numerical vector), then the numerical vector goes through a stack of self-attention layers of the transformer, where they become semantically richer by attending to the rest of the tokens in the sequence. The output of the transformer is a new “contextualized” representation for each of these tokens, which can be used to solve different tasks, such as translation, or summarization.

Example self-supervised modeling tasks described herein use the MLM. The self-supervised modeling task includes masking a certain percentage or portion of tokens in the input with one or more <MASK> special token. The model predicts the original token using the rest of the un-masked tokens (e.g., using context surrounding the masked token). This task produces a loss value during evaluations of the inputs, which represents a deviation in the prediction from ground truth data. As training iterations continue, respective loss values decrease to a point of diminishing returns that may trigger a stopping point of model iteration.

An example second pre-training stage disclosed herein for a general-purpose language model is pre-training the transformer model with example supervised tasks using supervised data. Supervised data is data that has been annotated or labelled (e.g., by a human). The supervised modeling task compares the output (prediction) of the machine learning model with a labeled annotation. These labeled annotations refer to the task of interest contrary to the self-supervised annotations. If the model's prediction is quite far from the actual target, then the model's error signal will be high, and the model will have to make a stronger correction in its parameters. The error signal is based on a numerical difference between a prediction and ground truth information. On the other hand, if the prediction is close to the target, then the error signal will be lower and the model will have to make corrections of a relatively lower magnitude to its parameters, because it is already closer to the expected solution.

An example supervised task is a product matching task which includes grouping the data by UPC code (e.g., this information is available in the reference dataset). The transformer model receives a pair of product descriptions. If each of the products in the pair is products from the same group (e.g., products that have a matching UPC code), the pair of descriptions are treated as positives. If each of the products in the pair is not from the same group (e.g., products that do not have matching UPC code), the product descriptions are treated as negatives. The two descriptions are passed together in the input in a cross-encoder fashion. A special <CLS> token is attached to a classification head (e.g., feed forward layer) and is used to predict whether the two descriptions are a match (e.g., belong to the same UPC) or not.

An example second supervised task is a product group prediction task which includes predicting the product group of the pair of input descriptions. The product group information is stored in the reference dataset. The supervised task predicts the product group of the pair of input descriptions. The pair of product descriptions is fed to the transformer model substantially simultaneously with one product description on the right and one product description on the left. The transformer model predicts the product group for the left and right input descriptions independently. The average of the token embeddings is used as the representation for each of the left and right description, as described in further detail below. Each representation is attached to a classification head. The classification head is trained to predict the product group characteristics. This task confers knowledge about the category (also referred to as taxonomy) of the products to the model. For example, a “coke 300 ml” product description is categorized as a beverage. The “beverage” keyword is used as the product category or taxonomy.

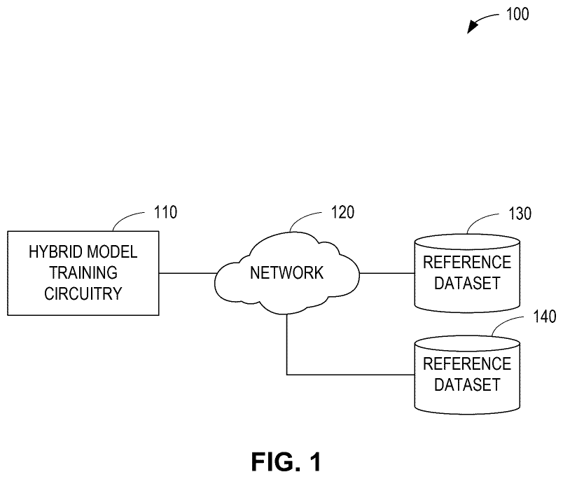

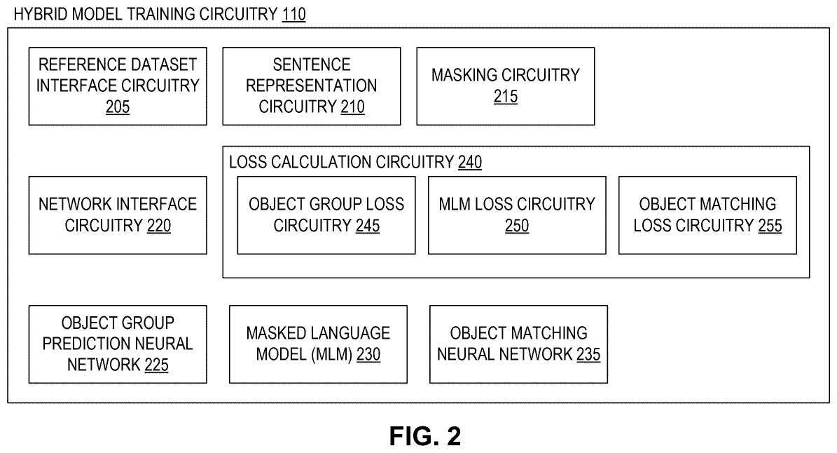

FIG. 1 is a block diagram of an example environment 100 in which an example hybrid model training circuitry operates to pre-train a machine learning model using semi-supervised signals. Example environment 100 includes an example hybrid model training circuitry 110, an example network 120, and example multiple reference datasets 130, 140. The example hybrid model training circuitry 110 is discussed below with reference to FIGS. 2 and 3. The example network 120 may be a router, hub or the internet, which communicatively connects the hybrid model training circuitry 110 to any number of databases or datasets 130, 140. The example reference datasets 130 and 140 are a collection of data that is used as a standard or benchmark for evaluating the performance of machine learning models. The reference datasets 130 and 140 may include labeled examples where the correct outputs are known.

FIG. 2 is a block diagram of an example implementation of the

hybrid model training circuitry 110 of FIG. 1 to pre-train a machine learning model with semi-supervised signals. The hybrid model training circuitry 110 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the hybrid model training circuitry 110 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example hybrid model training circuitry 110 includes example reference dataset interface circuitry 205, example sentence representation circuitry 210, example masking circuitry 215, example network interface circuitry 220, an example object group prediction neural network 225, an example masked language model (MLM) 230, an example object matching neural network 235, and example loss calculation circuitry 240 (which includes example object group loss circuitry 245, example MLM loss circuitry 250 and example object matching loss circuitry 255).

The example hybrid model training circuitry 110 operates to pre-train a machine learning model (e.g., a transformer model, as described above and in further detail below in connection with FIG. 3) using semi-supervised signals. Semi-supervised signals combine a self-supervised signal with two supervised signals to train the machine learning model. In some examples, the model is a transformer model. The transformer model can be a cross-encoder transformer or a bi-encoder model, but examples disclosed herein describe implementations of the cross-encoder transformer. A cross-encoder transformer uses a pair of inputs (e.g., sentences or tokenized sentences), where the goal is to find relationships between the two input sentences. For example, if the pair of input sentences represent product descriptions, the cross-encoder transformer determines whether the two descriptions belong to the same product. The cross-encoder transformer receives a pair of product descriptions simultaneously with one product description on the right and one product description on the left. For example, consider a first input sentence (e.g., first product description) such as “coke 330 ml” versus a second input sentence “cke ml volume 330” (e.g. second product description). At least one objective of the cross-encoder transformer is to determine whether these two sentences refer to the same product.

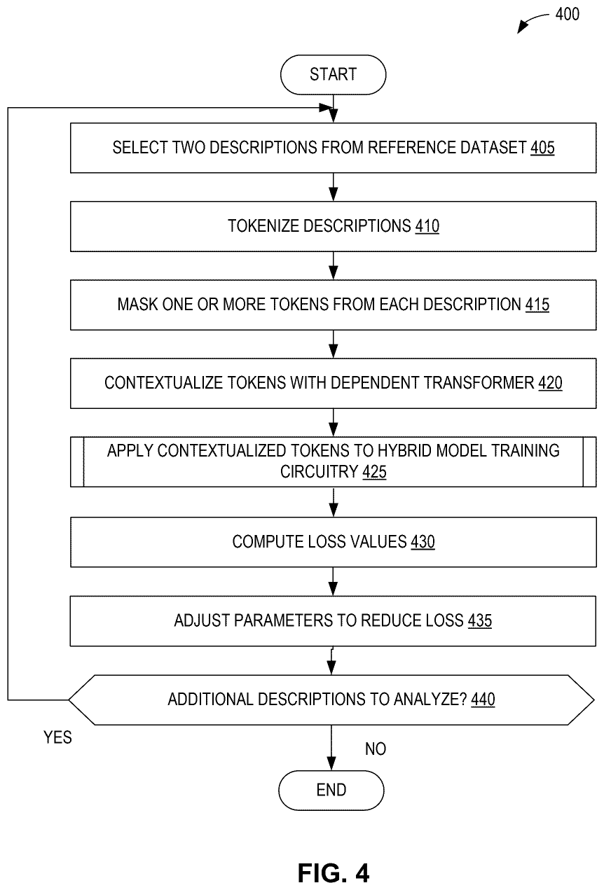

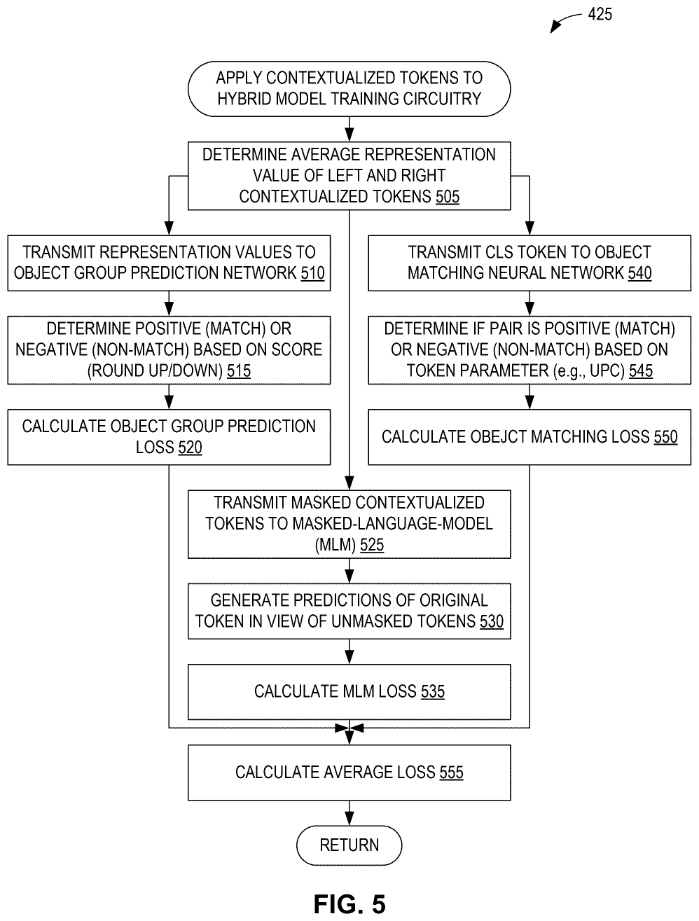

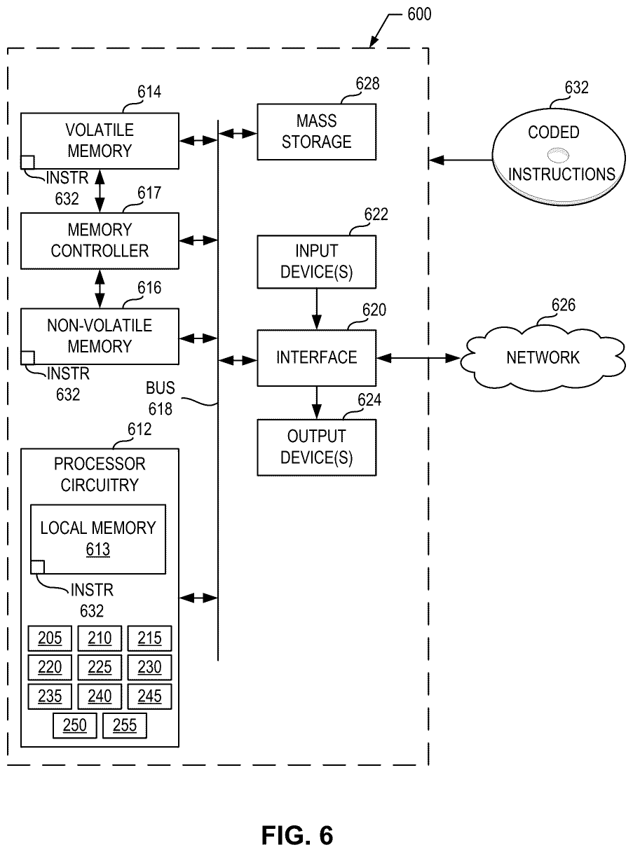

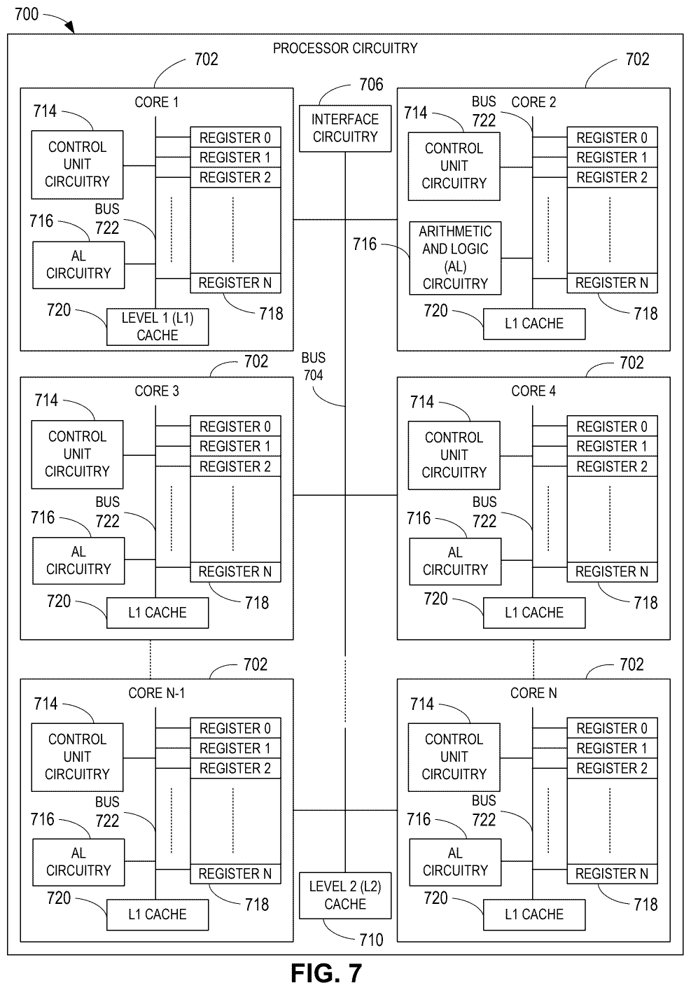

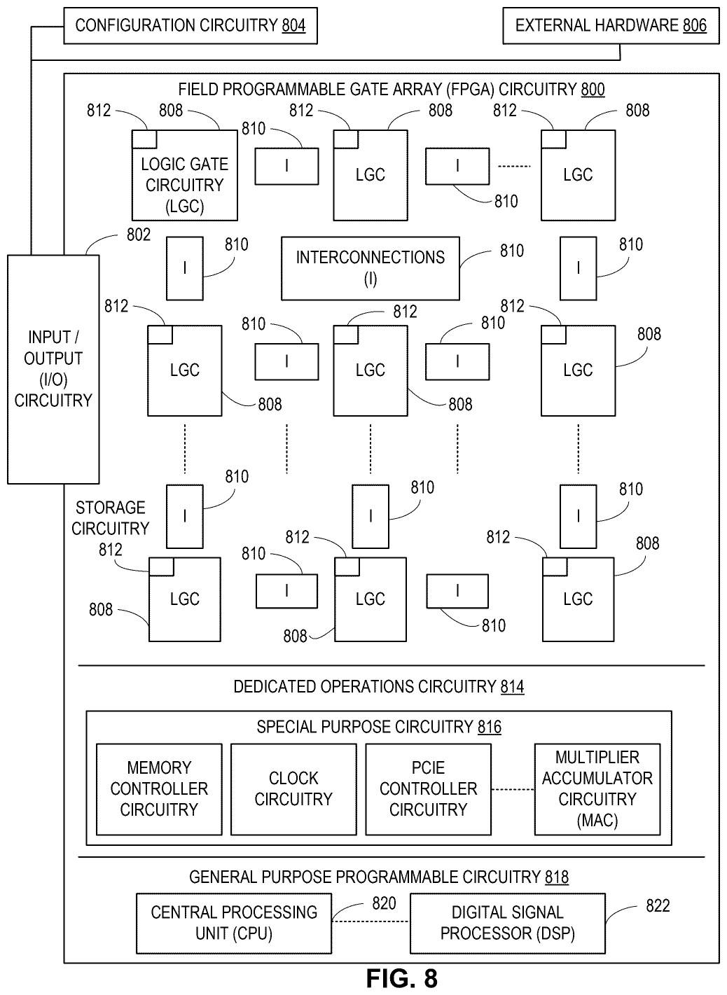

In some examples, the hybrid model training circuitry 110 includes means for hybrid model training, means for interfacing datasets, means for tokenizing, means for masking, means for interfacing neural networks, means for object group prediction, means for masked language modeling, means for object matching, and means for loss calculation. The example means for loss calculation includes means for object group loss calculation, means for MLM loss calculation, and means for object matching loss calculation. For example, the means for hybrid model training may be implemented by the hybrid model training circuitry 110, the means for interfacing datasets may be implemented by the reference dataset interface circuitry 205, the means for tokenizing may be implemented by the sentence representation circuitry 210, the means for masking may be implemented by the masking circuitry 215, means for interfacing neural networks may be implemented by the network interface circuitry 220, means for object group prediction may be implemented by the object group prediction neural network 225, means for masked language modeling may be implemented by the masked language model (MLM) 230, means for object matching may be implemented by the object matching neural network 235, the means for loss calculation may be implemented by the loss calculation circuitry 240, the means for object group loss calculation may be implemented by the object group loss circuitry 245, the means for MLM loss calculation may be implemented by the MLM loss circuitry 250, and the means for object matching loss calculation may be implemented by the object matching loss circuitry 255. In some examples, the aforementioned circuitry may be instantiated by programmable circuitry such as the example programmable circuitry 612 of FIG. 6. For instance, the aforementioned circuitry may be instantiated by the example microprocessor 700 of FIG. 7 executing machine executable instructions such as those implemented by the blocks of FIGS. 4-5. In some examples, the aforementioned circuitry may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the aforementioned circuitry may be instantiated by any other combination of hardware, software, and/or firmware. For example, the aforementioned circuitry may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

FIG. 3 is a block diagram of an example modeling framework 300 to train a machine learning model with semi-supervised signals. In the illustrated example of FIG. 3, framework 300 includes an example transformer model 302, an example sequence of input tokens 304, which includes example first product description tokens 306, example second product description tokens 308, and an example separator token <September> 309. The sequence of input tokens 304 includes a first token 312 and a second token 316, both of which are to be masked as described in further detail below. The example framework 300 also includes an example second sequence of tokens 310, an example first masked token <MASK> 314 that masks the first token 312, an example second mask token <MASK> 318 that masks the second token 316, and an example third sequence of tokens 320 that have been contextualized by the example transformer model 302. The third sequence of tokens 320 includes a contextualized first product description 322 and a contextualized second product description 324. The example framework 300 includes an example first average representation 326 that is based on the contextualized first product description 322 and an example second average representation 328 that is based on the contextualized second product description 324. The example framework 300 includes an example first object group prediction neural network 225a corresponding to the first contextualized product description 322 and an example second object group prediction neural network 225b corresponding to the second contextualized product description 324. The example third sequence of tokens 320 also includes a contextualized classification token 334, a contextualized first masked token 338, and a contextualized second masked token 340. The example framework 300 includes an example first object group loss circuitry 245a, an example second object group loss circuitry 245b. The framework 300 also includes the circuitry of FIG. 2. For example, the masking circuitry 215, the MLM 230, the object matching neural network 235, the loss calculation circuitry 240, the MLM loss circuitry 250, and the object matching loss circuitry 255.

In the illustrated example of FIG. 3, the example machine learning model 302 (also referred to as transformer model) receives a pair of input descriptions, such as the first product description tokens 306 and the second product description tokens 308. The reference dataset interface circuitry 205 (FIG. 2) interfaces with and/or otherwise accesses the reference dataset(s) 130, 140 (FIG. 1) to sample or select two example input descriptions to form the pair of input descriptions.

The example transformer model 302 is trained for one or more epochs. To illustrate, consider an input dataset that includes one hundred (100) pairs of product descriptions, in which each pair is considered a sample of the dataset. Additionally, consider that the dataset is divided up into a discrete number of batches, such as ten (10) batches of ten (10) samples (e.g., pairs). An example training iteration may include selecting ten random samples from the dataset to be associated with a first batch (e.g., a data structure of concatenated samples). The first batch is sent and/or otherwise transmitted to the example pipeline 300 as inputs to first product description tokens 306 and second product description tokens 308.

As described above and in further detail below, the pipeline 300 processes the batch and makes a prediction for each of the ten samples and computes ten associated loss values. The ten loss values are averaged to produce one single loss value, which is used to adjust the parameters of the model 302 with a goal of reducing the loss value. After the first batch of ten samples is processed, a next randomly selected batch of ten samples is selected as input to the pipeline 300. At the completion of all batches of the dataset, one epoch is complete.

In some examples, two or more epochs are applied to the pipeline in view of the dataset, in which the samples (e.g., pairs) will be processed a subsequent time as the model 302 continues to adjust parameters and improve. A number of epochs to include during training may be designated as a hyperparameter and/or determined in an empirical manner. In some examples, monitoring performance on a validation dataset is used to determine the optimal number of epochs for training a machine learning model 302. If the performance of the validation dataset starts to degrade (e.g., validation loss increases), it is an indication that the model 302 is overfitted. Training may be stopped to prevent overfitting. Overfitting occurs when a machine learning model 302 learns to memorize the training dataset rather than generalize from it. The optimal number of epochs is the point at which the performance on the validation dataset starts to plateau or degrade. This indicates that the model 302 has converged, and further training may not yield significant improvements. Once the optimal number of epochs is determined, the model 302 can be trained using the entire training dataset with that number of epochs and its performance can be evaluated.

The sentence representation circuitry 210 (FIG. 2) tokenizes the input descriptions to generate a sequence of tokens 304. The sentence representation circuitry 210 divides text in the input descriptions into individual words or sub-words (e.g., tokens). As described above, the sequence of tokens 304 includes the first tokenized description 306 (e.g., a description on the left), and a second tokenized description 308 (e.g., a description on the right). The two tokenized descriptions 306, 308 are separated by a separator token <SEP> 309. The first tokenized description 306 includes “COK COL 330 ML”. The first, second and fourth tokens in the first tokenized description 306 are represented as human-readable characters, but in some examples the descriptions are tokenized as numerical representations of their corresponding characters. Similarly, the first, second and fourth tokens in the second tokenized description 308, “PEP MA 220 ML” are represented as human-readable characters. Each of these tokens are assigned by the sentence representation circuitry 210 as a numerical representation (vector). Vectors are numerical representations of the token and permit comparisons to other tokens in the input description. The transformer model 302 learns these numerical representations during training. During training, these numerical representations go through a stack of self-attention layers of the transformer model 302 where the numerical representations interact with each other and generate context information indicative of semantic relationships between each token. Based on the training, the transformer model 302 adjusts these numerical representations to accurately represent the meaning of a token and its relationship to other tokens in the input descriptions.

After the input descriptions are tokenized, the masking circuitry 215 masks certain tokens in the input sequence of tokens 304. The masking circuitry 215 masks (e.g., randomly) a portion of the input sequence of tokens 304 to generate the second input sequence 310 with a randomly masked token. For example, in the illustrated example of FIG. 3, the masking circuity 215 masks one of the tokens in the first tokenized description 306 by replacing “COL” token 312 with the first masked token <MASK> 314. The masking circuitry 215 masks one of the tokens in the second tokenized description 308 by replacing “ML” token 316 with the second masked token <MASK> 318.

The example network interface circuitry 220 (in some examples masking circuitry 215 is used) transmits the second sequence of masked tokens 310 to the transformer model 302. The transformer model 302 contextualizes the second sequence of masked tokens 310 to generate the third sequence of contextualized tokens 320. The transformer model 302 learns the meaning and numerical representation of the tokens based on the context in which the tokens appear. The transformer model 302 produces contextualized representations of the tokens 320 based on their surrounding context in the input description 306, 308. For example, the transformer model 302 contextualizes the first input tokens 306 to generate the first contextualized representations 322 and contextualizes the second input tokens 308 to generate the second contextualized representations 324. The output of the transformer is a contextualized representation for each of these tokens, which can be used to solve different tasks. The contextualized representation for each of the tokens is a numerical representation (e.g., vector).

The sentence representation circuitry 210 calculates the first average representation 326 associated with the first contextualized representations 322 and calculates the second average representation 328 associated with the second contextualized representations 324. The sentence representation circuitry 210 averages the representation of the tokens belonging to the left input description 306 to produce one single representation, which is the first average representation 326 associated with the left input description 306. Similarly, the sentence representation circuitry 210 averages the representation of the tokens belonging to the right input description 308 to produce one single representation, which is the second average representation 328 associated with the right input description 308. These average representations 326, 328 are the input of the object group prediction neural network 225 (e.g., the classification head) to produce a prediction on a product group. A classification head is used to refer to a small feed forward network (FFN) that converts input representations into an actual prediction for a task of interest.

The network interface circuitry 220 feeds, inserts and/or otherwise transmits the first average representation 326 and the second average representation 328 to the example object group prediction neural network 225. The object group prediction neural network 225 performs the first supervised modeling task to train the transformer model 302. In the illustrated example of FIG. 3, the object group prediction neural network 225 is shown as a first object group prediction neural network 225a and a second object group prediction neural network 225b. The network interface circuitry 220 feeds, inserts and/or otherwise provides the first average representation 326 to the first object group prediction neural network 225a and feeds, inserts and/or otherwise provides the second average representation 328 to the second object group prediction neural network 225b.

The object group prediction neural networks 225a, 225b predict a group classification of the input tokens 306, 308. The object group prediction neural networks 225a, 225b produce and/or otherwise output a group classification prediction based on the average representations 326, 328 of the input tokens 306, 308. In other words, the first object group prediction neural network 225a predicts which product group the first product description input 306 belongs to out of the several hundred thousand possible product groups. The second object group prediction neural network 225b predicts which product group the second product description input 308 belongs to out of the several hundred thousand of possible product groups. The object group prediction neural network 225a, 225b is also referred to as a group classifier model. In some examples, the object group prediction neural network 225a, 225b is a small feed forward network (FFN) that converts input representations into an actual prediction for a task of interest.

The object matching neural network 235 predicts whether the two input descriptions 306, 308 are matching (e.g., from the same product group). The object matching neural network 235 performs the second supervised task to train the transformer model 302. The network interface circuitry 220 feeds, inserts, provides and/or otherwise transmits a contextualized representation 334 of a classification token <CLS> 336 to the object matching neural network 235 (e.g., a second classification head). The classification token <CLS> 336 is added at the beginning of the input tokens 304 to summarize the input 304 and serves as the basis for making predictions or decisions of the input descriptions 304.

The object matching neural network 235 takes the <CLS>

token contextualized representation 334 as input, and outputs a single value between 0 and 1. The single value is a similarity score of the pair of input descriptions 306, 308. For example, if the object matching neural network 235 predicts a value of 0.2, because this value is closer to 0, then the prediction will be that the pair of input descriptions 306, 308 is negative, which means that the two input descriptions 306, 308 refer to different products. If the predicted value were closer to 1 (e.g., above a particular threshold, such as 0.50) then the prediction would be positive, which means that the two input descriptions 306, 308 refer to the same product.

The network interface circuitry 220 feeds, inserts, provides and/or otherwise transmits the conceptualized representations 338, 340 of the masked tokens 314, 318 to the example MLM 230. The MLM 230 performs one or more self-supervised tasks to train the transformer model 302, such as predicting the original input token 312, 316. By forecasting masked tokens 314, 318, depending on surrounding context, MLM 230 helps the transformer model 302 to learn contextual information. This makes it possible for the transformer model 302 to represent the connections and dependencies among words in the input sequence 304.

Each of the different tasks to train the transformer model 302 has a corresponding loss that quantifies the discrepancy between the predicted value and the ground truth value, guiding the transformer model's learning process towards making accurate predictions. The example three tasks disclosed herein corresponding to the semi-supervised architecture 300 include two supervised tasks (e.g., object group prediction, object matching) and one self-supervised task (e.g., MLM).

The object group loss circuitries 245a, 245b calculates object group prediction losses. The object group loss circuitries 245a, 245b calculate the object group prediction loss value corresponding to a group classification. The object group loss circuitries 245a, 245b calculate the object group prediction loss value by comparing the predicted value to an expected value. In the illustrated example of FIG. 3, the object group loss circuitry 245a calculates a first object group prediction loss value associated with the object group prediction of the first input description 306. The object group loss circuitry 245b calculates a second object group prediction loss value associated with the object group prediction of the second input description 308.

The object matching loss circuitry 255 calculates an object matching loss value. The object matching loss value is associated with the object matching prediction. The object matching loss circuitry 255 calculates the object matching loss value based on the similarity or difference between the predicted value and the expected value.

The MLM loss circuitry 250 calculates a MLM loss for each masked token. The MLM loss circuitry 250 calculates a discrepancy between the predicted probability distribution over a vocabulary and true distribution of the masked token. For each masked token 314, 318 in the input sequence 304, the transformer model 302 predicts the probability distribution over the entire vocabulary of tokens. This distribution represents the model's confidence about which token(s) should replace the masked token given the surrounding context. The true distribution of the masked token represents the ground truth label for the masked position. It is a numerical vector where a prediction corresponding to the originally masked token is 1, and all other predictions are 0. The MLM loss circuitry 250 produces an MLM loss that accounts for the deviation in the prediction.

The transformer model 302 is trained based on an average loss 350 that is calculated by the loss calculation circuitry 240 by combining the losses from the semi-supervised signals (e.g., two supervised signals and one self-supervised signal). In particular, the average loss 350 is a function of the object group loss, the object matching loss, and the MLM loss. The average loss 350 decreases over time as the transformer model 302 learns to better fit the training data. At the beginning of training, the average loss 350 tends to be higher as the model's parameters are randomly initialized, and its predictions may be far from the ground truth labels. As training progresses, the loss decreases as the model adjusts its parameters to minimize the discrepancy between predicted and true value.

If the transformer model 302 is trained in batches of ten samples (e.g., pairs of product descriptions), the object matching neural network 235, the object group prediction neural network 225a, 225b, and the MLM 230 make a prediction for each of the ten samples and average loss calculation circuitry 240 computes ten associated losses. These ten losses are averaged to produce one single loss value 350. The average loss value(s) 350 generated by the example loss calculation circuitry 240 are transmitted back to the example transformer 302 during training of the transformer 302. The loss value 350 is used to adjust the parameters of the transformer model 302 with the goal of reducing the loss value. The transformer model 302 repeats another training iteration choosing other ten samples from the dataset. An epoch is complete when all the samples in the dataset have been used. Training stops when a target number of epochs (e.g., a hyperparameter) have occurred during training of the model 302.

While an example manner of implementing the hybrid model training circuitry 110 of FIG. 1 is illustrated in FIG. 2, one or more of the elements, processes, and/or devices illustrated in FIG. 2 may be combined, divided, re-arranged, omitted, eliminated, and/or implemented in any other way. Further, the example reference dataset interface circuitry 205, the example sentence representation circuitry 210, the example masking circuitry 215, the example network interface circuitry 220, the example object group prediction neural network 225, the example masked language model (MLM) 230, the example object matching neural network 235, and the example loss calculation circuitry 240 (which includes an example object group loss circuitry 245, the example MLM loss circuitry 250 and the example object matching loss circuitry 255), and/or, more generally, the example hybrid model training circuitry 110 of FIG. 2, may be implemented by hardware alone or by hardware in combination with software and/or firmware. Thus, for example, any of the example reference dataset interface circuitry 205, the example sentence representation circuitry 210, the example masking circuitry 215, the example network interface circuitry 220, the example object group prediction neural network 225, the example masked language model (MLM) 230, the example object matching neural network 235, and the example loss calculation circuitry 240 (which includes an example object group loss circuitry 245, the example MLM loss circuitry 250 and the example object matching loss circuitry 255), and/or, more generally, the example hybrid model training circuitry 110, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example hybrid model training circuitry 110 of FIG. 2 may include one or more elements, processes, and/or devices in addition to, or instead of, those illustrated in FIG. 2, and/or may include more than one of any or all of the illustrated elements, processes and devices.

Flowchart(s) representative of example machine readable instructions, which may be executed by programmable circuitry to implement and/or instantiate the hybrid model training circuitry 110 of FIG. 2 and/or representative of example operations which may be performed by programmable circuitry to implement and/or instantiate the hybrid model training circuitry of FIG. 2, are shown in FIGS. 4-5. The machine readable instructions may be one or more executable programs or portion(s) of one or more executable programs for execution by programmable circuitry such as the programmable circuitry 612 shown in the example processor platform 600 discussed below in connection with FIG. 6 and/or may be one or more function(s) or portion(s) of functions to be performed by the example programmable circuitry (e.g., an FPGA) discussed below in connection with FIGS. 7 and/or 8. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 4-5, many other methods of implementing the example hybrid model training circuitry 110 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 4-5 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 4 is a flowchart representative of example machine readable instructions and/or example operations 400 that may be executed, instantiated, and/or performed by programmable circuitry to train machine learning models using semi-supervised signals.

The example machine-readable instructions and/or the example operations 400 of FIG. 4 begin at block 405, at which the example reference dataset interface circuitry 205 (FIG. 2) selects two descriptions from reference dataset 130, 140 (FIG. 1). As described above in conjunction with FIG. 2, the two descriptions can be product descriptions or any other descriptions. The example sentence representation circuitry 210 (FIG. 2) tokenizes the two descriptions (block 410). In some examples, tokenizing the descriptions includes splitting the product descriptions into a sequence of tokens (e.g., numerical representations of characters and/or words of the descriptions). The example masking circuitry 215 (FIG. 2) masks one or more tokens from each description (block 415). The masking circuitry 215 randomly masks a percentage or quantity of tokens from each description. The tokens that are masked are replaced with a special (e.g., masking) token (e.g., <MASK>). The network interface circuitry 220 (FIG. 2) transmits the tokens to a transformer model 302 (FIG. 3). The transformer model 302 contextualizes the input tokens and the masking tokens (block 420). The network interface circuitry 220 transmits the contextualized tokens to the hybrid model training circuitry 110 (FIG. 2) (block 425), as further described below in connection with FIG. 5.

The loss calculation circuitry 240 (FIG. 2) computes a loss value 350 (block 430). The loss calculation circuitry 240 calculates the loss value 350 by combining the losses from the semi-supervised signals (e.g., two supervised signals and one self-supervised signal), as described above in connection with FIG. 3 and below in connection with FIG. 5.

The loss value 350 is fed back to the transformer model 302. The transformer model 302 uses the loss value 350 to adjust parameters of the model with the goal of reducing the loss value 350 (block 435). At block 440, the reference dataset interface circuitry 205 determines whether there are additional descriptions to analyze. If there are additional descriptions to analyze (block 440: YES), control returns to the start of the example operations 400 (block 405). If there are no additional descriptions to analyze (block 440: NO), the example instructions and/or operations 400 of FIG. 4 end.

FIG. 5 is a flowchart representative of example machine readable instructions and/or example operations 425 that may be executed, instantiated, and/or performed by programmable circuitry to apply contextualized tokens to the hybrid model training circuitry 110 by combining supervised and self-supervised signals. The example machine-readable instructions and/or the example operations 425 of FIG. 5 begin at block 505, at which the example sentence representation circuitry 210 (FIG. 2) determines an average representation value of the left and right contextualized tokens. For example, and described above in connection with FIG. 3, the sentence representation circuitry 210 generates the first average representation 326 based on the contextualized first product description 322 and the second average representation 328 based on the contextualized second product description 324. The network interface circuitry 220 transmits the average representation values (e.g., the first average representation 326 and the second average representation 328) to a corresponding object group prediction neural network 225 (block 510). In particular, the network interface circuitry 220 transmits the first average representation 326 to the corresponding first object group prediction neural network 225a and transmits the second average representation 328 to the corresponding second object group prediction neural network 225b.

The object group prediction neural network 225 determines a positive (e.g., match) or a negative (e.g., non-match) value for the pair of descriptions based on a score (e.g., average representation) that is rounded up or down (block 515). The object group loss circuitry 245 calculates an object group prediction loss (block 520) based on a comparison of a predicted value to an expected value. Control proceeds to block 555 at which the loss calculation circuitry 240 uses the object group prediction loss value as one of the inputs (e.g., first input) to calculate an average loss value.

Returning to block 505, the control concurrently proceeds to block 525 at which the network interface circuitry 220 transmits masked contextualized tokens to a masked language model (MLM). The MLM 230 generates one or more predictions of original tokens in view of unmasked tokens (block 530). The MLM loss circuitry 250 calculates the MLM losses (block 535). Control proceeds to block 555 at which the loss calculation circuitry 240 uses the MLM loss value as a second input to calculate an average loss value.

Returning to block 505, control concurrently proceeds to block 540 at which the network interface circuitry 220 transmits a CLS token to an object matching neural network 235 (block 540). The object matching neural network 235 determines if the pair of description is positive (e.g., match) or negative (e.g., non-match) based on target parameter such as UPC (block 545). The object matching loss circuitry 255 calculates a matching loss value (block 550). Control proceeds to block 555 at which the loss calculation circuitry 240 uses the matching loss value as a third input to calculate an average loss value.

Unlike traditional techniques to determine loss values when training a model, which may calculate loss based on a single type of analysis, examples disclosed herein determine a relatively more comprehensive and/or robust loss value based on both supervised and self-supervised techniques. The transformer model 302 is trained for one or more epochs. One epoch may include 100 pairs of product descriptions. Each pair of product descriptions is one sample in a dataset. In some examples, the transformer model 302 is trained in batches of ten samples (e.g., pairs of product descriptions). In some examples, ten random samples from the dataset are chosen without replacement and concatenated in a batch (e.g., concatenated together to form a data structure). The batch (e.g., with the ten samples) is sent to the transformer model 302, and the transformer model 302 processes the batch to make a prediction for each of the ten samples. The example average loss calculation circuitry 240 computes, in this example scenario, ten associated losses, which are averaged to produce one single loss value 350. The average loss value(s) 350 generated by the example loss calculation circuitry 240 are transmitted back to the example transformer 302 during training of the transformer 302. The loss value 350 is used to adjust the parameters of the transformer model 302 with the goal of reducing the loss value. The transformer model 302 repeats another training iteration choosing other ten samples from the dataset. An epoch is complete when all the samples in the dataset have been used. If the transformer model 302 is to train for two or more epochs, then each sample will be processed a respective two or more times.

Traditional techniques to determine loss values for a transformer also suffer from time consuming and resource intensive pre-training of self-supervised data. For instance, pre-training typically includes trillions of words and/or tokens in an effort to learn an underlying structure of inputs (e.g., the domain of the input data). As described above, such self-supervised data lacks context and/or specificity of targeted modeling tasks for specific domains of interest (e.g., a product domain, a pharmaceutical domain). Additionally, efforts to include supervised and/or otherwise labeled inputs to transformer model pre-training suffer from accuracy and bias error, particularly when a relative volume of supervised data is less than the volume of self-supervised data. Such limitations cause computational inefficiencies in re-training efforts that examples disclosed herein overcome by incorporating a hybrid training framework. The example hybrid training framework 300 disclosed herein provides a model that requires less labelled data (e.g., supervised data), which is costly and reduces the amount of training time (e.g., training iterations) to converge. In particular, because fewer iterations are needed in view of examples disclosed herein, related processing resources (e.g., CPUs, graphical processing units (GPUs), memory, etc.) consume less power and lower network transmission bandwidth.

After analysis and training of a first pair of description tokens (e.g., first product description tokens 306 and second product description tokens 308), control returns to the example instructions and/or operations of block 430 of FIG. 4.

FIG. 6 is a block diagram of an example programmable circuitry platform 600 structured to execute and/or instantiate the example machine-readable instructions and/or the example operations of FIGS. 4-5 to implement the hybrid model training circuitry 110 of FIG. 2. The programmable circuitry platform 600 can be, for example, a server, a personal computer, a workstation, a self-learning machine (e.g., a neural network), or any other type of computing and/or electronic device.

The programmable circuitry platform 600 of the illustrated example includes programmable circuitry 612. The programmable circuitry 612 of the illustrated example is hardware. For example, the programmable circuitry 612 can be implemented by one or more integrated circuits, logic circuits, FPGAs, microprocessors, CPUs, GPUs, DSPs, and/or microcontrollers from any desired family or manufacturer. The programmable circuitry 612 may be implemented by one or more semiconductor based (e.g., silicon based) devices. In this example, the programmable circuitry 612 implements the example reference dataset interface circuitry 205, the example sentence representation circuitry 210, the example masking circuitry 215, the example network interface circuitry 220, the example object group prediction neural network 225, the example masked language model (MLM) 230, the example object matching neural network 235, and the example loss calculation circuitry 240 (which includes the example object group loss circuitry 245, the example MLM loss circuitry 250 and the example object matching loss circuitry 255).

The programmable circuitry 612 of the illustrated example includes a local memory 613 (e.g., a cache, registers, etc.). The programmable circuitry 612 of the illustrated example is in communication with main memory 614, 616, which includes a volatile memory 614 and a non-volatile memory 616, by a bus 618. The volatile memory 614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 616 may be implemented by flash memory and/or any other desired type of memory device. Access to the main memory 614, 616 of the illustrated example is controlled by a memory controller 617. In some examples, the memory controller 617 may be implemented by one or more integrated circuits, logic circuits, microcontrollers from any desired family or manufacturer, or any other type of circuitry to manage the flow of data going to and from the main memory 614, 616.

The programmable circuitry platform 600 of the illustrated example also includes interface circuitry 620. The interface circuitry 620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 622 are connected to the interface circuitry 620. The input device(s) 622 permit(s) a user (e.g., a human user, a machine user, etc.) to enter data and/or commands into the programmable circuitry 612. The input device(s) 622 can be implemented by, for example, an audio sensor, a microphone, a camera (still or video), a keyboard, a button, a mouse, a touchscreen, a trackpad, a trackball, an isopoint device, and/or a voice recognition system.

One or more output devices 624 are also connected to the interface circuitry 620 of the illustrated example. The output device(s) 624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 620 of the illustrated example, thus, typically includes a graphics driver card, a graphics driver chip, and/or graphics processor circuitry such as a GPU.

The interface circuitry 620 of the illustrated example also

includes a communication device such as a transmitter, a receiver, a transceiver, a modem, a residential gateway, a wireless access point, and/or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 600 of the illustrated example also includes one or more mass storage discs or devices 628 to store firmware, software, and/or data. Examples of such mass storage discs or devices 628 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 632, which may be implemented by the machine readable instructions of FIGS. 4-5, may be stored in the mass storage device 628, in the volatile memory 614, in the non-volatile memory 616, and/or on at least one non-transitory computer readable storage medium such as a CD or DVD which may be removable.

FIG. 7 is a block diagram of an example implementation of the programmable circuitry 612 of FIG. 6. In this example, the programmable circuitry 612 of FIG. 6 is implemented by a microprocessor 700. For example, the microprocessor 700 may be a general-purpose microprocessor (e.g., general-purpose microprocessor circuitry). The microprocessor 700 executes some or all of the machine-readable instructions of the flowcharts of FIGS. 4-5 to effectively instantiate the circuitry of FIG. 2 as logic circuits to perform operations corresponding to those machine readable instructions. In some such examples, the circuitry of FIG. 2 is instantiated by the hardware circuits of the microprocessor 700 in combination with the machine-readable instructions. For example, the microprocessor 700 may be implemented by multi-core hardware circuitry such as a CPU, a DSP, a GPU, an XPU, etc. Although it may include any number of example cores 702 (e.g., 1 core), the microprocessor 700 of this example is a multi-core semiconductor device including N cores. The cores 702 of the microprocessor 700 may operate independently or may cooperate to execute machine readable instructions. For example, machine code corresponding to a firmware program, an embedded software program, or a software program may be executed by one of the cores 702 or may be executed by multiple ones of the cores 702 at the same or different times. In some examples, the machine code corresponding to the firmware program, the embedded software program, or the software program is split into threads and executed in parallel by two or more of the cores 702. The software program may correspond to a portion or all of the machine readable instructions and/or operations represented by the flowcharts of FIGS. 4-5.

The cores 702 may communicate by a first example bus 704. In some examples, the first bus 704 may be implemented by a communication bus to effectuate communication associated with one(s) of the cores 702. For example, the first bus 704 may be implemented by at least one of an Inter-Integrated Circuit (I2C) bus, a Serial Peripheral Interface (SPI) bus, a PCI bus, or a PCIe bus. Additionally or alternatively, the first bus 704 may be implemented by any other type of computing or electrical bus. The cores 702 may obtain data, instructions, and/or signals from one or more external devices by example interface circuitry 706. The cores 702 may output data, instructions, and/or signals to the one or more external devices by the interface circuitry 706. Although the cores 702 of this example include example local memory 720 (e.g., Level 1 (L1) cache that may be split into an L1 data cache and an L1 instruction cache), the microprocessor 700 also includes example shared memory 710 that may be shared by the cores (e.g., Level 2 (L2 cache)) for high-speed access to data and/or instructions. Data and/or instructions may be transferred (e.g., shared) by writing to and/or reading from the shared memory 710. The local memory 720 of each of the cores 702 and the shared memory 710 may be part of a hierarchy of storage devices including multiple levels of cache memory and the main memory (e.g., the main memory 614, 616 of FIG. 6). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 702 may be referred to as a CPU, DSP, GPU, etc., or any other type of hardware circuitry. Each core 702 includes control unit circuitry 714, arithmetic and logic (AL) circuitry (sometimes referred to as an ALU) 716, a plurality of registers 718, the local memory 720, and a second example bus 722. Other structures may be present. For example, each core 702 may include vector unit circuitry, single instruction multiple data (SIMD) unit circuitry, load/store unit (LSU) circuitry, branch/jump unit circuitry, floating-point unit (FPU) circuitry, etc. The control unit circuitry 714 includes semiconductor-based circuits structured to control (e.g., coordinate) data movement within the corresponding core 702. The AL circuitry 716 includes semiconductor-based circuits structured to perform one or more mathematic and/or logic operations on the data within the corresponding core 702. The AL circuitry 716 of some examples performs integer based operations. In other examples, the AL circuitry 716 also performs floating-point operations. In yet other examples, the AL circuitry 716 may include first AL circuitry that performs integer-based operations and second AL circuitry that performs floating-point operations. In some examples, the AL circuitry 716 may be referred to as an Arithmetic Logic Unit (ALU).

The registers 718 are semiconductor-based structures to store data and/or instructions such as results of one or more of the operations performed by the AL circuitry 716 of the corresponding core 702. For example, the registers 718 may include vector register(s), SIMD register(s), general-purpose register(s), flag register(s), segment register(s), machine-specific register(s), instruction pointer register(s), control register(s), debug register(s), memory management register(s), machine check register(s), etc. The registers 718 may be arranged in a bank as shown in FIG. 7. Alternatively, the registers 718 may be organized in any other arrangement, format, or structure, such as by being distributed throughout the core 702 to shorten access time. The second bus 722 may be implemented by at least one of an I²C bus, a SPI bus, a PCI bus, or a PCIe bus.

Each core 702 and/or, more generally, the microprocessor 700 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 700 is a semiconductor device fabricated to include many transistors interconnected to implement the structures described above in one or more integrated circuits (ICs) contained in one or more packages.

The microprocessor 700 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 700, in the same chip package as the microprocessor 700 and/or in one or more separate packages from the microprocessor 700.

FIG. 8 is a block diagram of another example implementation of the programmable circuitry 612 of FIG. 6. In this example, the programmable circuitry 612 is implemented by FPGA circuitry 800. For example, the FPGA circuitry 800 may be implemented by an FPGA. The FPGA circuitry 800 can be used, for example, to perform operations that could otherwise be performed by the example microprocessor 700 of FIG. 7 executing corresponding machine readable instructions. However, once configured, the FPGA circuitry 800 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 700 of FIG. 7 described above (which is a general purpose device that may be programmed to execute some or all of the machine readable instructions represented by the flowchart(s) of FIGS. 4-5 but whose interconnections and logic circuitry are fixed once fabricated), the FPGA circuitry 800 of the example of FIG. 8 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 4-5. In particular, the FPGA circuitry 800 may be thought of as an array of logic gates, interconnections, and switches. The switches can be programmed to change how the logic gates are interconnected by the interconnections, effectively forming one or more dedicated logic circuits (unless and until the FPGA circuitry 800 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 4-5. As such, the FPGA circuitry 800 may be configured and/or structured to effectively instantiate some or all of the operations/functions corresponding to the machine readable instructions of the flowchart(s) of FIGS. 4-5 as dedicated logic circuits to perform the operations/functions corresponding to those software instructions in a dedicated manner analogous to an ASIC. Therefore, the FPGA circuitry 800 may perform the operations/functions corresponding to the some or all of the machine readable instructions of FIGS. 4-5 faster than the general-purpose microprocessor can execute the same.

In the example of FIG. 8, the FPGA circuitry 800 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 800 of FIG. 8 may access and/or load the binary file to cause the FPGA circuitry 800 of FIG. 8 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 800 of FIG. 8 to cause configuration and/or structuring of the FPGA circuitry 800 of FIG. 8, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 800 of FIG. 8 may access and/or load the binary file to cause the FPGA circuitry 800 of FIG. 8 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 800 of FIG. 8 to cause configuration and/or structuring of the FPGA circuitry 800 of FIG. 8, or portion(s) thereof.

The FPGA circuitry 800 of FIG. 8, includes example input/output (I/O) circuitry 802 to obtain and/or output data to/from example configuration circuitry 804 and/or external hardware 806. For example, the configuration circuitry 804 may be implemented by interface circuitry that may obtain a binary file, which may be implemented by a bit stream, data, and/or machine-readable instructions, to configure the FPGA circuitry 800, or portion(s) thereof. In some such examples, the configuration circuitry 804 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 806 may be implemented by external hardware circuitry. For example, the external hardware 806 may be implemented by the microprocessor 700 of FIG. 7.

The FPGA circuitry 800 also includes an array of example logic gate circuitry 808, a plurality of example configurable interconnections 810, and example storage circuitry 812. The logic gate circuitry 808 and the configurable interconnections 810 are configurable to instantiate one or more operations/functions that may correspond to at least some of the machine readable instructions of FIGS. 4-5 and/or other desired operations. The logic gate circuitry 808 shown in FIG. 8 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 808 to enable configuration of the electrical structures and/or the logic gates to form circuits to perform desired operations/functions. The logic gate circuitry 808 may include other electrical structures such as look-up tables (LUTs), registers (e.g., flip-flops or latches), multiplexers, etc.

The configurable interconnections 810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 808 to program desired logic circuits.

The storage circuitry 812 of the illustrated example is structured to store result(s) of the one or more of the operations performed by corresponding logic gates. The storage circuitry 812 may be implemented by registers or the like. In the illustrated example, the storage circuitry 812 is distributed amongst the logic gate circuitry 808 to facilitate access and increase execution speed.

The example FPGA circuitry 800 of FIG. 8 also includes example dedicated operations circuitry 814. In this example, the dedicated operations circuitry 814 includes special purpose circuitry 816 that may be invoked to implement commonly used functions to avoid the need to program those functions in the field. Examples of such special purpose circuitry 816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 800 may also include example general purpose programmable circuitry 818 such as an example CPU 820 and/or an example DSP 822. Other general purpose programmable circuitry 818 may additionally or alternatively be present such as a GPU, an XPU, etc., that can be programmed to perform other operations.

Although FIGS. 7 and 8 illustrate two example implementations of the programmable circuitry 612 of FIG. 6, many other approaches are contemplated. For example, FPGA circuitry may include an on-board CPU, such as one or more of the example CPU 820 of FIG. 7. Therefore, the programmable circuitry 612 of FIG. 6 may additionally be implemented by combining at least the example microprocessor 700 of FIG. 7 and the example FPGA circuitry 800 of FIG. 8. In some such hybrid examples, one or more cores 702 of FIG. 7 may execute a first portion of the machine readable instructions represented by the flowchart(s) of FIGS. 4-5 to perform first operation(s)/function(s), the FPGA circuitry 800 of FIG. 8 may be configured and/or structured to perform second operation(s)/function(s) corresponding to a second portion of the machine readable instructions represented by the flowcharts of FIG. 4-5, and/or an ASIC may be configured and/or structured to perform third operation(s)/function(s) corresponding to a third portion of the machine readable instructions represented by the flowcharts of FIGS. 4-5.

It should be understood that some or all of the circuitry of FIG. 2 may, thus, be instantiated at the same or different times. For example, same and/or different portion(s) of the microprocessor 700 of FIG. 7 may be programmed to execute portion(s) of machine-readable instructions at the same and/or different times. In some examples, same and/or different portion(s) of the FPGA circuitry 800 of FIG. 8 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 700 of FIG. 7 may execute machine readable instructions in one or more threads executing concurrently and/or in series. In some examples, the FPGA circuitry 800 of FIG. 8 may be configured and/or structured to carry out operations/functions concurrently and/or in series. Moreover, in some examples, some or all of the circuitry of FIG. 2 may be implemented within one or more virtual machines and/or containers executing on the microprocessor 700 of FIG. 7.

In some examples, the programmable circuitry 612 of FIG. 6 may be in one or more packages. For example, the microprocessor 700 of FIG. 7 and/or the FPGA circuitry 800 of FIG. 8 may be in one or more packages. In some examples, an XPU may be implemented by the programmable circuitry 612 of FIG. 6, which may be in one or more packages. For example, the XPU may include a CPU (e.g., the microprocessor 700 of FIG. 7, the CPU 820 of FIG. 8, etc.) in one package, a DSP (e.g., the DSP 822 of FIG. 8) in another package, a GPU in yet another package, and an FPGA (e.g., the FPGA circuitry 800 of FIG. 8) in still yet another package.

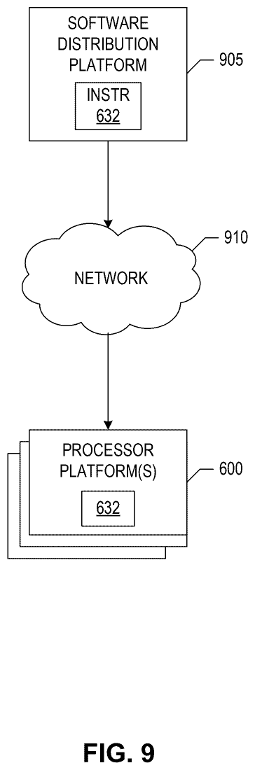

A block diagram illustrating an example software distribution platform 905 to distribute software such as the example machine readable instructions 632 of FIG. 6 to other hardware devices (e.g., hardware devices owned and/or operated by third parties from the owner and/or operator of the software distribution platform) is illustrated in FIG. 9. The example software distribution platform 905 may be implemented by any computer server, data facility, cloud service, etc., capable of storing and transmitting software to other computing devices. The third parties may be customers of the entity owning and/or operating the software distribution platform 905. For example, the entity that owns and/or operates the software distribution platform 905 may be a developer, a seller, and/or a licensor of software such as the example machine readable instructions 632 of FIG. 6. The third parties may be consumers, users, retailers, OEMs, etc., who purchase and/or license the software for use and/or re-sale and/or sub-licensing. In the illustrated example, the software distribution platform 905 includes one or more servers and one or more storage devices. The storage devices store the machine readable instructions 632, which may correspond to the example machine readable instructions of FIGS. 4-5, as described above. The one or more servers of the example software distribution platform 905 are in communication with an example network 910, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 632 from the software distribution platform 905. For example, the software, which may correspond to the example machine readable instructions of FIG. 4-5, may be downloaded to the example programmable circuitry platform 600, which is to execute the machine readable instructions 632 to implement the hybrid model training circuitry. In some examples, one or more servers of the software distribution platform 905 periodically offer, transmit, and/or force updates to the software (e.g., the example machine readable instructions 632 of FIG. 6) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time +/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that train machine learning models based on semi-supervised signals. Disclosed systems, apparatus, articles of manufacture, and methods improve the pre-training of machine learning models with semi-supervised signals. Examples disclosed herein determine a relatively more comprehensive and/or robust loss value based on both supervised and self-supervised techniques. The self-supervised techniques include pre-training using trillions of unlabeled words and/or tokens in an effort to learn an underlying structure of inputs and the supervised techniques complement the input by adding context or semantic to the input using metadata associated with the task at hand. The average loss value(s) of the semi-supervised signals are transmitted back to the machine learning model on an iterative basis during training of the model. The machine learning model iteratively analyzes a current description tokens to generate updated contextualized token values used as input to an object matching neural network, an object group prediction neural networks and an MLM. Disclosed systems, apparatus, articles of manufacture, and methods are accordingly directed to one or more improvement(s) in the training of machine learning models.

Example methods, apparatus, systems, and articles of manufacture to train a foundational machine learning model based on semi-supervised signals are disclosed herein. Further examples and combinations thereof include the following:

Example 1 includes an apparatus comprising interface circuitry, machine-readable instructions, and at least one processor circuit to be programmed by the machine-readable instructions to tokenize a first input and a second input to generate first tokens and second tokens, generate context information based on transformer self attention layer interaction between the first tokens and the second tokens, the self attention layer interaction to generate numerical values for respective ones of the first tokens and the second tokens, insert a first average value of the first tokens to a first group classifier model to predict a first group classification, insert a second average value of the second tokens to a second group classifier model to predict a second group classification, the first and second group classifier models trained with supervised data associated with the first and second inputs, insert masked ones of the first tokens and second tokens to a masked language model, and train a transformer based on an average loss value associated with (a) a first loss value corresponding to the first group classification, (b) a second loss value corresponding to the second group classification, (c) a third loss value corresponding to the MLM, and (d) a fourth loss value corresponding to an object matching neural network.

Example 2 includes the apparatus of example 1, wherein the transformer is a cross encoder transformer.

Example 3 includes the apparatus of example 1, wherein the training of the transformer stops based on a target number of epochs.

Example 4 includes the apparatus of example 3, wherein the number of epochs is determined based on performance of a validation dataset.

Example 5 includes the apparatus of example 1, wherein the group classifier model and the object matching neural network is a feed forward network.

Example 6 includes the apparatus of example 1, wherein the first input and the second input are descriptions selected from reference dataset.

Example 7 includes the apparatus of example 1, wherein the object matching neural network is to predict whether the first input and the second input are positive or negative.

Example 8 includes a non-transitory machine readable storage medium comprising instructions to cause programmable circuitry to at least tokenize a first input and a second input to generate first tokens and second tokens, generate context information based on transformer self-attention layer interaction between the first tokens and the second tokens, the self-attention layer interaction to generate numerical values for respective ones of the first tokens and the second tokens, feed a first average value of the first tokens to a first group classifier model to predict a first group classification, feed a second average value of the second tokens to a second group classifier model to predict a second group classification, the first and second group classifier models trained with supervised data associated with the first and second inputs, feed masked ones of the first tokens and second tokens to a masked language model, and train a transformer based on an average loss value associated with (a) a first loss value corresponding to the first group classification, (b) a second loss value corresponding to the second group classification, (c) a third loss value corresponding to the MLM, and (d) a fourth loss value corresponding to an object matching neural network.

Example 9 includes the non-transitory machine readable storage medium of example 8, wherein the transformer is a cross encoder transformer.

Example 10 includes the non-transitory machine readable storage medium of example 8, wherein the training of the transformer stops based on a target number of epochs.

Example 11 includes the non-transitory machine readable storage medium of example 10, wherein the number of epochs is determined based on performance of a validation dataset.

Example 12 includes the non-transitory machine readable storage medium of example 8, wherein the group classifier model and the object matching neural network is a feed forward network.

Example 13 includes the non-transitory machine readable storage medium of example 8, wherein the first input and the second input are descriptions selected from reference dataset.

Example 14 includes the non-transitory machine readable storage medium of example 8, wherein the object matching neural network is to predict whether the first input and the second input are positive or negative.

Example 15 includes a method comprising tokenizing a first input and a second input to generate first tokens and second tokens, generating context information based on transformer self-attention layer interaction between the first tokens and the second tokens, the self-attention layer interaction to generate numerical values for respective ones of the first tokens and the second tokens, feeding a first average value of the first tokens to a first group classifier model to predict a first group classification, feeding a second average value of the second tokens to a second group classifier model to predict a second group classification, the first and second group classifier models trained with supervised data associated with the first and second inputs, feeding masked ones of the first tokens and second tokens to a masked language model, and training a transformer based on an average loss value associated with (a) a first loss value corresponding to the first group classification, (b) a second loss value corresponding to the second group classification, (c) a third loss value corresponding to the MLM, and (d) a fourth loss value corresponding to an object matching neural network.

Example 16 includes the method of example 15, wherein the transformer is a cross encoder transformer.

Example 17 includes the method of example 15, wherein the training of the transformer stops based on a target number of epochs.

Example 18 includes the method of example 17, wherein the number of epochs is determined based on performance of a validation dataset.

Example 19 includes the method of example 15, wherein the group classifier model and the object matching neural network is a feed forward network.

Example 20 includes the method of example 15, wherein the object matching neural network further includes predicting whether the first input and the second input are positive or negative.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
machine-readable instructions; and
at least one processor circuit to be programmed by the machine-readable instructions to:
tokenize a first input and a second input to generate first tokens and second tokens;
generate context information based on transformer self attention layer interaction between the first tokens and the second tokens, the self attention layer interaction to generate numerical values for respective ones of the first tokens and the second tokens;
insert a first average value of the first tokens to a first group classifier model to predict a first group classification;
insert a second average value of the second tokens to a second group classifier model to predict a second group classification, the first and second group classifier models trained with supervised data associated with the first and second inputs;
insert masked ones of the first tokens and second tokens to a masked language model; and
train a transformer based on an average loss value associated with (a) a first loss value corresponding to the first group classification, (b) a second loss value corresponding to the second group classification, (c) a third loss value corresponding to the MLM, and (d) a fourth loss value corresponding to an object matching neural network.

2. The apparatus of claim 1, wherein the transformer is a cross encoder transformer.

3. The apparatus of claim 1, wherein the training of the transformer stops based on a target number of epochs.

4. The apparatus of claim 3, wherein the number of epochs is determined based on performance of a validation dataset.

5. The apparatus of claim 1, wherein the group classifier model and the object matching neural network is a feed forward network.

6. The apparatus of claim 1, wherein the first input and the second input are descriptions selected from reference dataset.

7. The apparatus of claim 1, wherein the object matching neural network is to predict whether the first input and the second input are positive or negative.

8. A non-transitory machine readable storage medium comprising instructions to cause programmable circuitry to at least:
tokenize a first input and a second input to generate first tokens and second tokens;
generate context information based on transformer self-attention layer interaction between the first tokens and the second tokens, the self-attention layer interaction to generate numerical values for respective ones of the first tokens and the second tokens;
feed a first average value of the first tokens to a first group classifier model to predict a first group classification;
feed a second average value of the second tokens to a second group classifier model to predict a second group classification, the first and second group classifier models trained with supervised data associated with the first and second inputs;
feed masked ones of the first tokens and second tokens to a masked language model; and
train a transformer based on an average loss value associated with (a) a first loss value corresponding to the first group classification, (b) a second loss value corresponding to the second group classification, (c) a third loss value corresponding to the MLM, and (d) a fourth loss value corresponding to an object matching neural network.

9. The non-transitory machine readable storage medium of claim 8, wherein the transformer is a cross encoder transformer.

10. The non-transitory machine readable storage medium of claim 8, wherein the training of the transformer stops based on a target number of epochs.

11. The non-transitory machine readable storage medium of claim 10, wherein the number of epochs is determined based on performance of a validation dataset.

12. The non-transitory machine readable storage medium of claim 8, wherein the group classifier model and the object matching neural network is a feed forward network.

13. The non-transitory machine readable storage medium of claim 8, wherein the first input and the second input are descriptions selected from reference dataset.

14. The non-transitory machine readable storage medium of claim 8, wherein the object matching neural network is to predict whether the first input and the second input are positive or negative.

15. A method comprising:
tokenizing a first input and a second input to generate first tokens and second tokens;
generating context information based on transformer self-attention layer interaction between the first tokens and the second tokens, the self-attention layer interaction to generate numerical values for respective ones of the first tokens and the second tokens;
feeding a first average value of the first tokens to a first group classifier model to predict a first group classification;
feeding a second average value of the second tokens to a second group classifier model to predict a second group classification, the first and second group classifier models trained with supervised data associated with the first and second inputs;
feeding masked ones of the first tokens and second tokens to a masked language model; and
training a transformer based on an average loss value associated with (a) a first loss value corresponding to the first group classification, (b) a second loss value corresponding to the second group classification, (c) a third loss value corresponding to the MLM, and (d) a fourth loss value corresponding to an object matching neural network.

16. The method of claim 15, wherein the transformer is a cross encoder transformer.

17. The method of claim 15, wherein the training of the transformer stops based on a target number of epochs.

18. The method of claim 17, wherein the number of epochs is determined based on performance of a validation dataset.

19. The method of claim 15, wherein the group classifier model and the object matching neural network is a feed forward network.

20. The method of claim 15, wherein the object matching neural network further includes predicting whether the first input and the second input are positive or negative.
